(19) United States
(12) Patent Application Publication
(10) Pub. No.: US 2005/0135738 A1
(43) Pub. Date: Jun. 23, 2005

(54) Broadband light source and broadband optical module using the same

(76) Inventors: Hyun-Cheol Shin, Suwon-si (KR); In-Kuk Yun, Suwon-si (KR); Seong-Taek Hwang, Pyeongtaek-si (KR); Jeong-Seok Lee, Anyang-si (KR)

Correspondence Address: CHA & REITER, LLC, 210 ROUTE 4 EAST STE 103, PARAMUS, NJ, 07652, US

(21) Appl. No.: 10/852,041

(22) Filed: May 24, 2004

(30) Foreign Application Priority Data
Dec. 23, 2003 (KR) 95261/2003

(51) Int. Cl. G02B 6/26

(52) U.S. Cl. 385/27

(57) ABSTRACT

Disclosed are a broadband light source and a broadband optical module using the broadband light source. The broadband light source includes a substrate, a plurality of waveguides including active layers for generating light of mutually differing wavelength bands, and formed on the substrate in order to extend from a first end to a second end of the broadband light source, a plurality of trenches located between waveguides in order to electrically and optically insulate the waveguides from each other, and a plurality of electrode devices for operating each of the waveguides.

### CLAIM OF PRIORITY

This application claims priority to an application entitled “Broadband Light Source and Broadband Optical Module Using the Same,” filed in the Korean Intellectual Property Office on Dec. 23, 2003 and assigned Serial No. 2003-95261, the contents of which are hereby incorporated by reference.

### BACKGROUND OF THE INVENTION

1. Field of the Invention

The present invention relates to a light source for generating light, and more particularly to a broadband light source for generating light of a broadband wavelength.

2. Description of the Related Art

A wavelength division multiplexed-passive optical network (WDM-PON) includes a central office for providing a communication service, a plurality of subscribers receiving the communication service from the central office, and a remote node connected to the central office through one optical fiber. The remote node receives optical signaling from the central office and demultiplexes the signaling downstream to the respective subscribers. The remote node likewise receives optical signals from the subscribers and outputs multiplexed optical signals upstream to the central office.

The downstream optical signals generated by the central office of mutually differing wavelengths so as to provide each downstream optical signals to a predetermined subscriber. Conversely, and the central office detects upstream optical signals having the mutually differing wavelengths inputted from subscribers.

The remote node is positioned adjacent to subscribers and linked to the central office through one optical fiber, so the optical fiber can be buried in an easy manner and it is possible to easily make communication lines.

The above-described wavelength division multiplexed-passive optical network uses mutually differing wavelength bands in such a manner that upstream optical signals are not overlapped with downstream optical signals, and may include a device capable of generating the upstream optical signals and downstream optical signals.

Such a device for generating the upstream optical signals and downstream optical signals may include one broadband light source and Fabry-Perot laser diodes fixed by the broadband light source.

The broadband light source uses spontaneous emitted light outputted through an erbium doped fiber amplifier (EDFA) or a semiconductor optical amplifier (SOA), and the spontaneous emitted light is de-multiplexed according to wavelengths thereof so as to lock each of wavelengths of the Fabry-Perot laser diodes.

However, the conventional method includes multiple broadband light sources in order to induce each of wavelength-locked upstream and downstream optical signals, entailing increased volume of the broadband light sources and cost.

### SUMMARY OF THE INVENTION

The present invention has been made to solve the above-mentioned problem occurring in the prior art and provides additional advantages, by providing a broadband light source capable of generating light of mutually differing wavelength bands.

In order to accomplish the above object, according to the present invention, there is provided a broadband light source including a substrate, a plurality of waveguides including active layers for generating light of mutually differing wavelength bands, and formed on the substrate in order to extend from a first end to a second end of the broadband light source, a plurality of trenches located between waveguides in order to electrically and optically insulate the waveguides from each other, and a plurality of electrode devices for operating each of the waveguides.

### BRIEF DESCRIPTION OF THE DRAWINGS

The above object, features and advantages of the present invention will be more apparent from the following detailed description taken in conjunction with the accompanying drawings, in which the same reference numerals are used to designate the same or similar components throughout the several views:

FIG. 1 is a sectional view showing a broadband light source according to a first embodiment of the present invention;

FIG. 2 is a plan view showing the broadband light source shown in FIG. 1;

FIG. 3 is a view showing a structure of an optical module including a broadband light source according to a second embodiment of the present invention;

FIG. 4 is a view showing an optical axis alignment of a broadband light source, an optical fiber, and lens located between the optical fiber and the broadband light source shown in FIG. 3; and

FIG. 5 is a spectrum showing a wavelength band of light outputted from a broadband light source according to one embodiment of the present invention.

### DETAILED DESCRIPTION

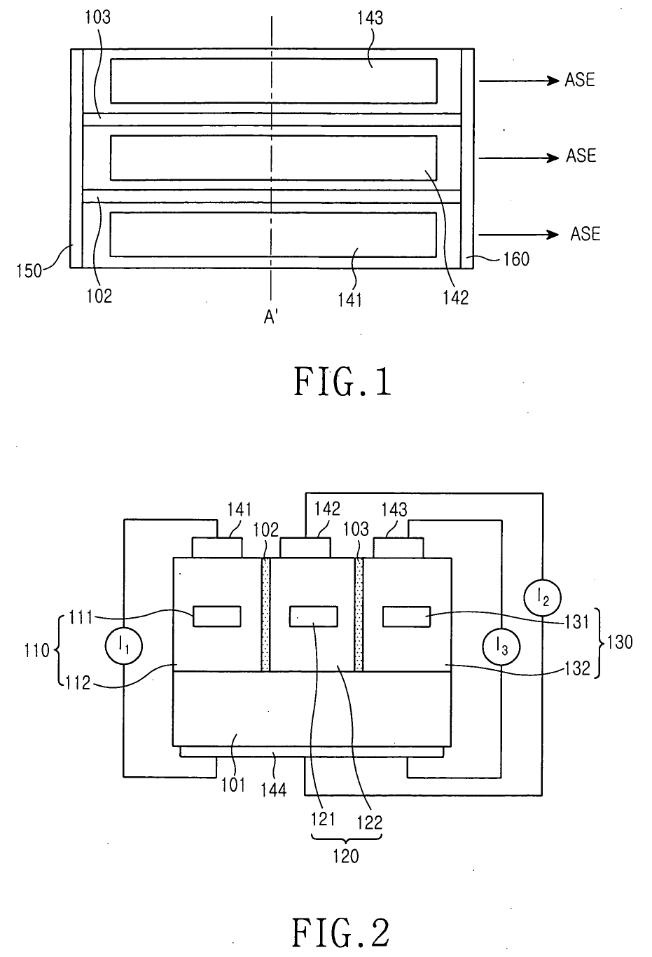

FIG. 1 is a sectional view showing a broadband light source according to a first embodiment of the present invention, FIG. 2 is a plan view showing the broadband light source shown in FIG. 1. Referring to FIGS. 1 to 2, the broadband light source according to the first embodiment of the present invention includes a substrate 101, a plurality of waveguides 110, 120, 130 generating light of mutually differing wavelength bands and outputting the light to a first end (not shown), a plurality of trenches 102, 103 located between waveguides 110, 120, 130, a plurality of electrode devices 141, 142, 143, 144 for operating each of waveguides 110, 120, 130, an anti-reflective layer 160, and a high-reflective layer 150.

The substrate 101 is provided on an upper surface thereof with the waveguides 110, 120, 130, and is provided at a lower surface thereof with a common electrode 144 of the waveguides 110, 120, 130.

The waveguides 110, 120, 130 consists of a first waveguide 110, a second waveguide 120, and a third waveguide 130, which generate light of mutually differing wavelength bands. The first to the third waveguides 110, 120, 130 output light of mutually differing wavelength bands towards the anti-reflective layer 160 of the broadband light source. The first to the third waveguides 110, 120, 130 respectively include active layers 111, 121, 131 having mutually differing band gaps, and clads 112, 122, 132 formed on the substrate 101 in such a manner that the clads surround the active layers.

The first waveguide 110 outputs light of an S-band corresponding to the wavelength band of 1490˜1530 mm through the anti-reflective layer 160 of the broadband light source. The second wavelength 120 outputs light of a C-band corresponding to a wavelength band of 1530˜1565 mm through the anti-reflective layer 160 of the broadband light source. Also, the third wavelength 130 outputs light of an L-band corresponding to a wavelength band of 1570˜1605 mm through the anti-reflective layer 160 of the broadband light source.

The first trench 102 is located between the first waveguide 110 and the second waveguide 120, and the second trench 103 is located between the second waveguide 120 and the third waveguide 130, so that the first to the third waveguides 110, 120 and 130 are electrically or optically insulated from each other.

The common electrode 144 is formed at a lower surface of the substrate 101, and first to third upper electrodes 141, 142, 143 are formed on upper portions of the first to the third waveguides 110, 120, 130 such that they are insulated from each other. Thus, the electrode devices 141, 142, 143. 144 independently apply current to the first to third waveguides 110, 120, 130 in order to operate each the waveguides.

The first upper electrode 141 is formed on the clad 112 of the first waveguide 110 in such a manner that the first upper electrode 141 is insulated from the second and the third upper electrodes 142, 143, and, in conjunction with the common electrode 144, applies a predetermined current to the first waveguide 110. The second upper electrode 142 is formed on the clad 122 of the second waveguide 120, and the third upper electrode 143 is formed on the clad 132 of the third waveguide 130.

The anti-reflective layer 160 is coated on a first end of the broadband light source in order to output the light to an exterior of the broadband light source by minimizing an optical loss outputted from the first to the third waveguides 110, 120, 130.

The high-reflective layer 150 is coated on a second end of the broadband light source so as to reflect light having mutually differing wavelengths created from the first to the third waveguides 110, 120, 130 towards the anti-reflective layer 160.

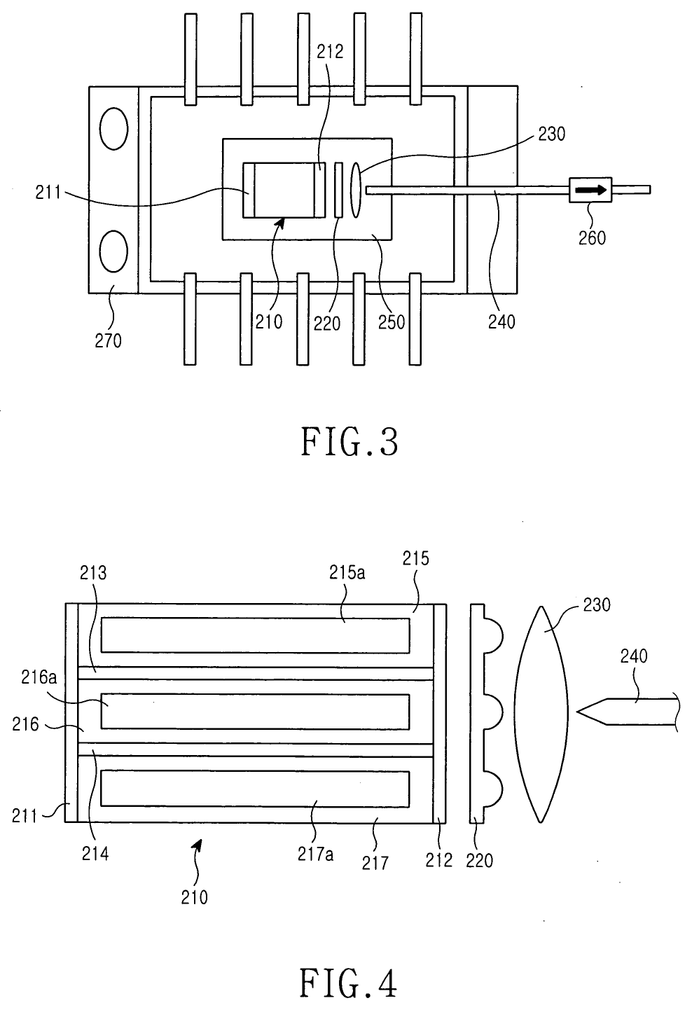

FIG. 3 is a view showing a structure of an optical module including a broadband light source according to a second embodiment of the present invention, and FIG. 4 is a view showing an optical axis alignment of a broadband light source, an optical fiber, and lens located between the optical fiber and the broadband light source shown in FIG. 3. Referring to FIGS. 3 and 4, the broadband light source according to the second embodiment of the present invention includes a broadband light source 210 generating light of mutually differing wavelength bands, an optical fiber 240, a micro lens array 220, a converged lens 230, and an isolator 260.

The broadband light source 210 includes first to third waveguides 215, 216, 217 grown on a substrate (not shown) in order to output light of the mutually differing wavelength bands, an anti-reflective layer 212 coated on one end of the broadband light source 210, a high-reflective layer 211 coated on the opposite end of the broadband light source 210, and first and second trenches 213, 214 located interleavingly between the first to third waveguides 215, 216, 217.

Each of the first to third waveguides 215, 216, 217 includes active layers (not shown) having mutually differing band gaps, and clads (not shown) formed on the substrate to surround the active layers. In addition, driving current is separately applied to each of the first to third waveguides 215, 216, 217 by means of first to third upper electrodes 215a, 216a, 217a formed on upper surfaces of the first to third waveguides and a common electrode (not shown) grown at a lower surface of the substrate.

The broadband light source 210 is a reflective SOA that separately applies driving current to each of the active layers having the mutually differing band gaps, so light of mutually differing wavelength bands may be outputted.

The light of mutually differing wavelength bands outputted from the broadband light source 210 includes spontaneous emitted light, so a wavelength band of the light can be controlled according to band gaps of the active layers or intensity of driving current applied to waveguides. The light of mutually differing wavelength bands outputted from the broadband light source 210 is outputted to the micro lens array 220 through the anti-reflective layer 212.

The micro lens array 220 is positioned opposed to the anti-reflective layer 212 of the broadband light source 210. The micro lens array 220 collimates each of light outputted from the broadband light source 210 so as to output light to the converged lens 230.

The converged lens 230 is located between the micro lens array 220 and the optical fiber 240, so as to converge light collimated through the micro lens array 220 into the optical fiber 240.

The optical fiber 240 outputs light inputted from the converged lens 230 to an exterior of the broadband light module.

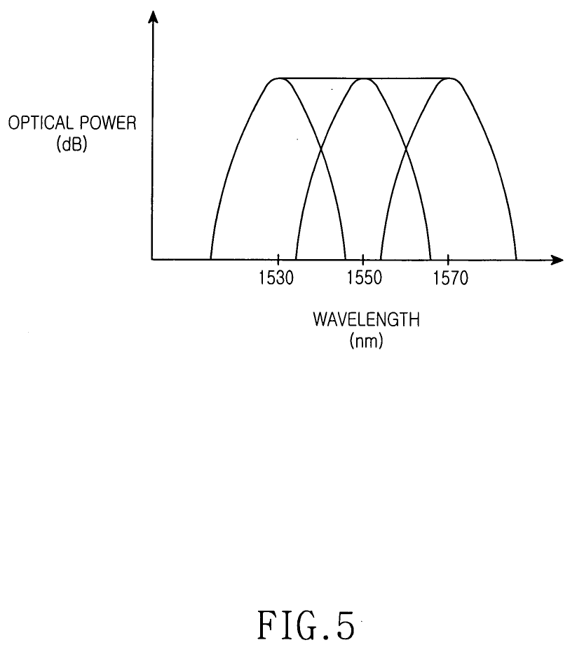

FIG. 5 is a spectrum showing wavelength bands of light outputted from a broadband light source according to the present invention. Referring to FIG. 5, the broadband light source according to the present invention can output light of broad wavelength bands, such as C-band, L-band, and S-band, for optical communication.

The present invention integrates on a single substrate waveguides having mutually differing band gaps, making it is possible to output light of broad wavelength bands by using one broadband light source.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A broadband light source comprising:
a substrate;
a plurality of waveguides including active layers for generating light of mutually differing wavelength bands, and formed on the substrate in order to extend from a first end to a second end of the broadband light source;
a plurality of trenches located between waveguides in order to electrically and optically insulate the waveguides from each other; and
a plurality of electrode devices for operating each of the waveguides.

2. The broadband light source according to claim 1, further comprising an anti-reflective layer coated on the first end in order to, in outputting the light from each of the waveguides, minimize an optical loss of the light, and a high-reflective layer coated on the second end in order to reflect the light generated from each of the waveguides towards the first end.

3. The broadband light source according to claim 1, wherein the first end is opposite the second end.

4. The broadband light source according to claim 1, wherein the electrode devices include a common electrode formed at a lower surface of the substrate, and a plurality of upper electrodes formed on each of the waveguides, the waveguides being electrically insulated from each other to afford individual operating of each of the waveguides.

5. The broadband light source according to claim 1, wherein each of the waveguides further includes a clad grown on the substrate in order to surround a periphery of the active layer.

6. The broadband light source according to claim 1, wherein each of the waveguides includes a first waveguide for generating a first light of an S-band, a second waveguide for generating a second light of a C-band, and a third waveguide for generating a third light of an L-band.

7. The broadband light source according to claim 1, wherein the broadband light source outputs light of mutually differing wavelength bands generated from each of the waveguides towards the first end.

8. The broadband light source according to claim 1, wherein the first end is opposite the second end.

9. The broadband light source according to claim 1, wherein the plural trenches are located interleavingly between the waveguides

10. A broadband optical module comprising:
a broadband light source having a first end, said source for generating light of mutually differing wavelength bands and outputting the light towards the first end;
a micro lens array located in opposition to the first end of the broadband light source in order to collimate light outputted from the broadband light source; and
a lens disposed and configured for converging the light collimated through the micro lens array into an optical fiber disposed for routing the converged light towards an exterior of the broadband optical module.

11. The broadband optical module according to claim 10, wherein the broadband light source has a second end, said module further comprising an anti-reflective layer coated on the first end in order to minimize loss of intensity for light outputted from the first end, and a high-reflective layer coated at said second end.

12. The broadband optical module according to claim 10, further comprising a sub-mount for mounting the broadband light source, the micro lens array, and the converged lens thereon, and a housing having a base section on which the sub-mount is rested, in such a manner that the broadband light source, the micro lens array, and the converged lens are protected from an external environment.

13. The broadband optical module according to claim 12, further including said optical fiber.

14. The broadband optical module according to claim 11, further including said optical fiber.

15. The broadband optical module according to claim 10, further including said optical fiber.

16. A broadband light source comprising:
a substrate;
a plurality of waveguides having active layers configured for emitting spontaneous light, each of the plural waveguides being formed on the substrate to extend from a first end to a second end of the broadband light source;
a plurality of trenches located between waveguides in order to electrically insulate the waveguides from each other, enabling the plural waveguides to generate respectively non-overlapping wavelength bands; and
electrical means for operating each of the waveguides.

17. The broadband light source according to claim 16, wherein the first end is opposite the second end.

18. The broadband light source according to claim 16, wherein the plural trenches are located interleavingly between the waveguides.

19. The broadband light source according to claim 16, further comprising an anti-reflective layer coated on the first end in order to, in outputting the light from each of the waveguides, minimize an optical loss of the light, and a high-reflective layer coated on the second end in order to reflect th light generated from each of the waveguides towards the first end.

20. The broadband light source according to claim 19, wherein the first end is opposite the second end.
